(19) United States
(12) Patent Application Publication
(10) Pub. No.: US 2004/0193575 A1
(43) Pub. Date: Sep. 30, 2004

(54) Path expressions and SQL select statement in object oriented language

(76) Inventors: Chia-Hsun Chen, Redmond, WA (US); Wolfram Schulte, Bellevue, WA (US); Barend H. Venter, Issaquah, WA (US); Erik Meijer, Mercer Island, WA (US); Christopher J. Lovett, Woodinville, WA (US); Matthew J. Warren, Redmond, WA (US)

Correspondence Address: Himanshu S. Amin, Amin & Turocy, LLP, National City Center, 1900 E. 9th Street, 24th Floor, Cleveland, OH, 44114, US

(21) Appl. No.: 10/396,866

(22) Filed: Mar. 25, 2003

(51) Int. Cl. G06F 7/00

(52) U.S. Cl. 707/3

(57) ABSTRACT

An object-oriented programming language with integrated query powers for both SQL and XML is disclosed. Portions of SQL select statement as well as XPath have been tightly integrated into a compiler and type system to provide for strongly typed programming and seamless access to both SQL and XML data.

### TECHNICAL FIELD

The present invention relates generally to computer systems, and more particularly to an object oriented computer language with integrated query capabilities.

### BACKGROUND

The future of e-commerce is largely dependant on the development of what are referred to as Web Services. Web Services are Internet based programmatic interfaces that provide valuable functions or services for users. For example, Microsoft Passport is a Web Service that facilitates user interaction by transferring user profile data to designated websites. The broad idea behind Web Services is to loosely couple heterogeneous computer infrastructures together to facilitate data transmission and computation to provide the user with a simple yet powerful experience. A key component to the functionality of Web Services is interaction with web data.

However, the world of web data is presently quite disjunctive. In the interest of clarity, FIG. 1 is provided. FIG. 1 is a Venn diagram illustrating a disjunctive state of web data. In general, there are three components that comprise the world of web data—relational data, self-describing data, and a runtime environment. A popular method of implementing a relational data model is by means of SQL (Structured Query Language). SQL is a language used to communicate with a relational database management system such as SQL Server, Oracle or Access, to retrieve, add, or manipulate data. Data in the relational database system is stored in tables. The accepted standard for self-describing data is XML (eXtensible Markup Language). XML is a W3C standard language that describes data via a schema or Document Type Definition (DTD). XML data is stored using tags. A runtime environment is a general-purpose multi-language execution engine (e.g., Common Language Runtime (CLR)) that allows authors to write programs that operate with relational data and/or self-describing data.

Although there is a developing trend toward storing data in XML documents, the majority of companies in the world have data stored in SQL as well as XML. However, companies need to be able to query, manipulate, integrate, and operate on data stored in diverse formats. Programmers presently employ APIs (Application Programming Interfaces) to bridge communication gaps between relational data, self-describing data, and a runtime environment. However, APIs are merely quick ad hoc fixes for the underlying interoperability problem.

Modern object oriented languages (e.g., C#, Visual Basic, etc) have very weak if any query power at all. The conventional approach to data access has been through the utilization of one or more application programming interfaces (APIs) as described supra. However, APls are not integrated into a language's type system and therefore they fail to provide support for debugging and static checking. Object-oriented program compilers therefore, simply accept any query expression as a string. Accordingly, if there is an error in the query expression, a compiler simply lets it go and leaves the programmer guessing at the cause of a produced runtime error.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention discloses a system and method for retrieving data from diverse data sources. More particularly, one system and method concerns retrieval of relational data from relational databases. In this case, an SQL select statement with support for additional expressions, such as hints and singleton keyword expressions, have been mapped into a compiler and type system of an object oriented programming language. The invention thus introduces power of the SQL select statement, including projection, inner and outer joins, and grouping into an object-oriented language. An additional concern relates to retrieving XML data from XML documents. With respect to XML, a W3C standard XPath has been used as a base for XML path expressions to retrieve data. Some additional functionality has been added to path expressions, such as filtering, aggregated expressions, groupby expressions, quantified expressions, sorting expressions, join expressions, and sequence expressions. Furthermore, support for path expressions have also been mapped into the type system and the language compiler.

Mapping expressions into an object-oriented language type system and compiler allows for strong type programming and debugging. Thus, the retrieval expressions select statement and path expression are strongly typed expressions in accordance with an aspect of the present invention. This allows programming functionality to be made easier, while also allowing seamless programmatic access to databases.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

FIG. 1 is a Venn diagram illustrating how conventional systems bridge technology gaps.

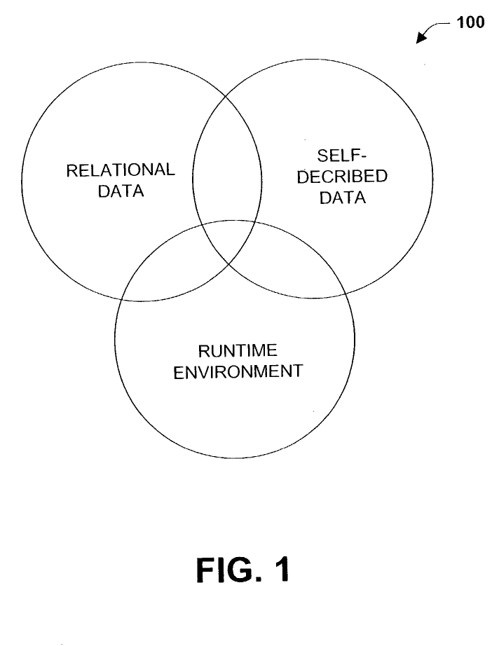

FIG. 2 is a Venn diagram illustrating a suitable method of bridging technology gaps in accordance with an aspect of the present invention.

FIG. 3 is a schematic block diagram of a generic system for retrieving data in accordance with an aspect of the present invention.

FIG. 4 is a block diagram of a system for retrieving relational data in accordance with an aspect of the present invention.

FIG. 5 is a sample relational database table in accordance with an aspect of the present invention.

FIG. 6 is a block diagram of a system for retrieving XML data in accordance with an aspect of the present invention.

FIG. 7 is a flow diagram depicting a method for retrieving relational data in accordance with an aspect of the present invention.

FIG. 8 is a flow diagram depicting a method for retrieving XML data in accordance with an aspect of the present invention.

FIG. 9 is a flow diagram illustrating a method of ensuring valid query expressions in accordance with an aspect of the present invention.

FIG. 10 is a schematic block diagram illustrating a suitable operating environment in accordance with an aspect of the present invention.

FIG. 11 is a schematic block diagram of a sample-computing environment with which the present invention can interact.

### DETAILED DESCRIPTION

The present invention is now described with reference to the annexed drawings, wherein like numerals refer to like elements throughout. It should be understood, however, that the drawings and detailed description thereto arc not intended to limit the invention to the particular form disclosed. Rather, the intention is to cover all modifications, equivalents, and alternatives falling within the spirit and scope of the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

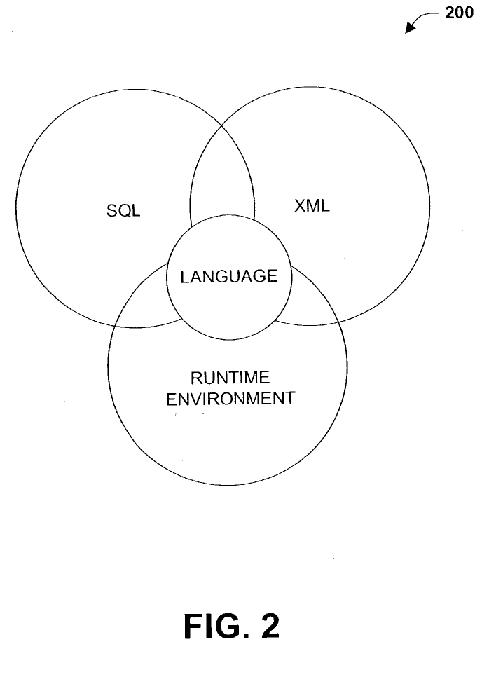

Turning initially to FIG. 2, a Venn diagram 200 is illustrated depicting a technique for bridging intersections between SQL, XML, and a runtime environment using a programming language. This invention, in particular, focuses on an interaction between XML and the runtime environment. XML is a defacto standard in data storage today. XML data is self-described via attached identifying symbols or tags. A runtime environment, inter alia, compiles high level programming languages into machine instructions that can subsequently be executed by a processor. As is illustrated, the present invention proposes a language solution to bridge technological gaps rather than utilizing APIs (Application Programming Interfaces), like the conventional technology. The language solution integrates the worlds of relational data (e.g., SQL), self-described data (e.g., XML), and a runtime environment (e.g., CLR or JVM) to present a coherent and unified interface to all three worlds. The amalgamation of worlds is accomplished by delving deeper than APIs and building a unified extended type system. Thus, the present invention facilitates incorporating some of the best features of many present day languages into a single cohesive language.

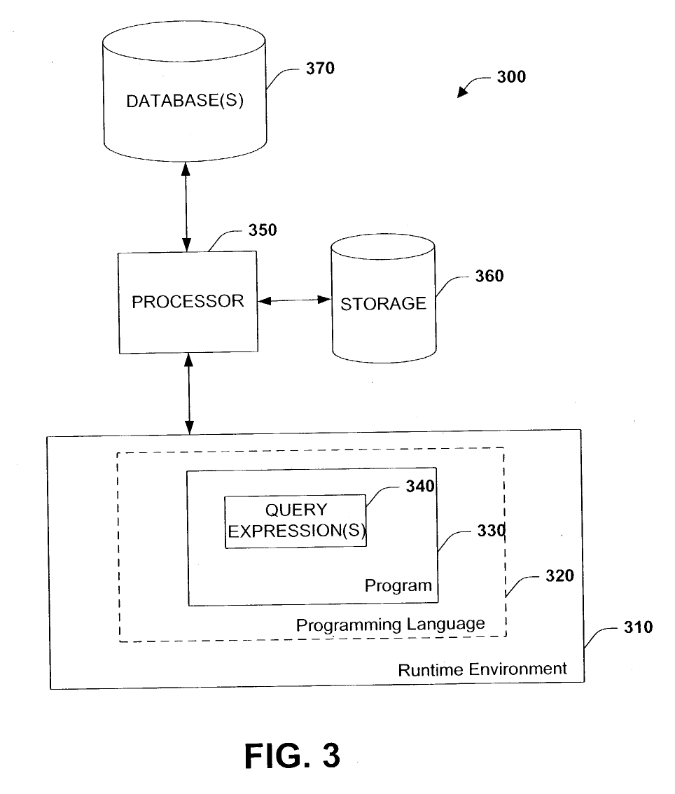

FIG. 3 depicts a system 300 for interacting with data in accordance with an aspect of the present invention. System 300 comprises runtime environment 310, programming language 320, program 330, query expression(s) 340, processor(s) 350, storage 360, and database(s) 370. Programming language 320 is run on top of a runtime environment 310 (e.g., Common Language Runtime (CLR), Java Virtual Machine (JVM)). Runtime environment 310, inter alia, provides services to the programming language 320 such as automatic memory management, code security, and debugging facilities, which allows authors to focus on an underlying logic of their applications rather than details of implementation. Programming language 320 provides a vocabulary and set of grammatical rules that authors can employ to implement a desired functionality of their applications. Additionally, programming language 320 is a strongly typed object-oriented language that is tightly integrated with a compiler and type system of the language 320. This allows programs to be thoroughly error checked prior to execution.

Program 330 employs vocabulary and grammatical rules of programming language 320 to develop an application. Once the program 330 is written, it is compiled. The program can be compiled into an intermediate language (IL) or directly to machine code. Processor 350 can then execute program 330 via runtime environment 310. Processor 350 can also interact with storage 360 to facilitate execution of program 330. Query expression(s) 340 can be a part of program 330. Query expression 340 is comprised of query tenns, logical operators, and special characters that specify how and which data is to be retrieved or manipulated. Database(s) 370 warehouses a large amount of data that can be accessed, retrieved, or otherwise manipulated programmatically. Database(s) are connected to and accessible by processor(s) 360. Thus, a program 320 during execution by processor 350 can retrieve data from database(s) 370 in accordance with specified query expression(s) 340.

In addition it should be appreciated that query expression(s) 340 will be type checked during a compilation process to ensure the expression(s) is valid. If query expression(s) 340 is invalid, intelligent support can be provided. Intelligent support may comprise prompting a program author to specify a correct syntax for the expression and/or employing a debugging facility that can offer suggestions for fixing a detected error.

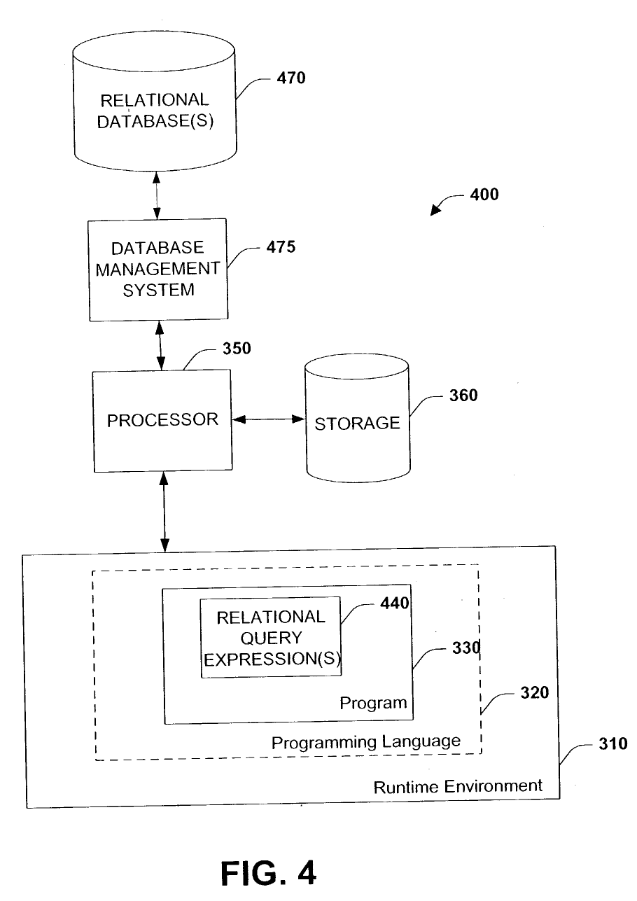

Turning to FIG. 4, a system 400 is illustrated for retrieving relational data in accordance with an aspect of the present invention. System 400 comprises runtine environment 310, programming language 320, program 330, relational query expression(s) 440, processor(s) 350, storage 360, and relational database(s) 470, and database management system 475. Programming language 320 is run on top of runtime environment 310 (e.g., Common Language Runtime (CLR), Java Virtual Machine (JVM)). Runtime environment 310, inter alia, provides services to the programming language 320 such as automatic memory management, code security, and debugging facilities, which allows authors to focus on an underling logic of their applications rather than details of implementation. Programming language 320 provides a vocabulary and set grammatical rules that authors can employ to implement a desired functionality of their applications. Additionally, programming language 320 is a strongly typed object-oriented language that is tightly integrated with a compiler and type system. This allows programs to be thoroughly error checked prior to execution.

Program 330 employs the vocabulary and grammatical rules of programming language 320 to develop an application. Once the program 330 is written, it is compiled.

The program may be compiled into an intermediate language (IL) or directly to machine code. Processor 350 can then execute program 330 via runtime environment 310. Processor 350 can also interact with storage 360 to facilitate execution of program 330.

Relational query expression(s) 440 can be a part of program 330. Relational query expression 440 is comprised of query terms, logical operators, and special characters that allow authors to specify how and which data is to be retrieved. One such relational query expression is a select-expression, described supra.

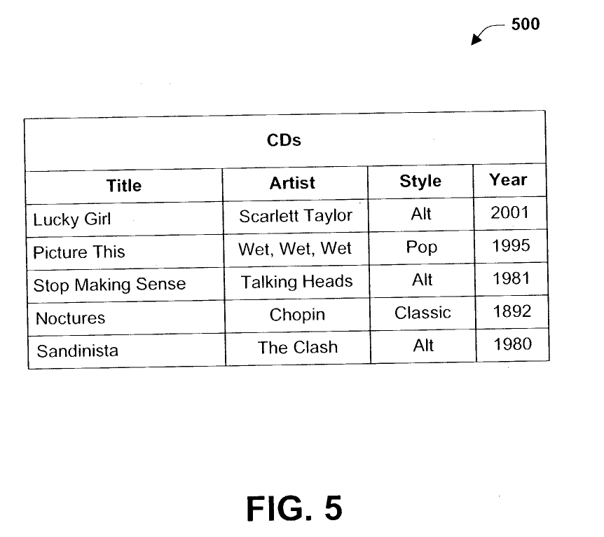

Relational database(s) 470 store massive amounts data that can be accessed, retrieved, or otherwise manipulated programmatically. Relational database(s) store data in tables. Referring briefly to FIG. 5, a sample table 500 is illustrated. Each table in a database can be uniquely identified by its name, CDs. Furthermore, each table contains a multitude of columns and rows. Each column has a name and data type associated with it, while rows are records of column information. In table 500, the columns are Title, Artist, Style, and Year, and there are seven rows that fill in the column information.

In order for queries to be executed against SQL tables, for instance, information representing the tables must exist in a way such that a compiler can reference the information at compile time. The standard model that a compiler uses to represent metadata is through the type system.

A select statement can be used to query against these SQL specific types. These types are representations of the SQL database schema frozen in time. How the compiler introduces new data types into a compilation process is compiler dependant, however a common mechanism of linking to external assemblies is at least one of the means to accomplish this.

For each table or view declared in a database, a structural type exists that describes column metadata. Each of these types is known as a tuple type or row. Tuple types are bare minimum information utilized to describe a single row of data from a table with a matching schema. Tuple types are not necessarily types that result from queries against the table instance. However, if no projection is made, then tuple type can be a default result set type.

Referring back to FIG. 4, relational database(s) 470 are connected to and accessible by database management system (DBMS) 475 (e.g., SQL Server). The processor(s) 360 is operably connected to the DBMS 475. Processor(s) 360 may retrieve data from relational database(s) 470 by requesting information from the DBMS 475 via a relational query expression.

The relational query expression select is powerful. The select expression includes support for projection, filtering, sorting, grouping and joining operations. In order facilitate employment of functional aspects of the select-expression, many parameters must be specified—some required and some optional. The following sections will describe some of formal details involved in employing the select-expression including from-clause, projections, sorting, grouping and aggregated functions, and sub-querying.

I. The from-clause

The from-clause is a required select-expression parameter employed to specify a source of a query. Grammar for the from-clause is shown below. The grammar will first be described broadly and then broken down and described in greater detail in following subsections.

```
from-clause:
      from binding-list where-clauseₒₚₜ
binding-list:
      binding
      binding , binding-list
binding:
      binding join-operator hintₒₚₜ binding on-condition
      ( binding join-operator hintₒₚₜ binding on-condition )
      variable-binding
variable-binding:
      [[type] identifier in ] conditional-or-expression hintₒₚₜ
join-operator:
      inner join
      left join
      right join
      full join
on-condition:
      on conditional-or-expression
hint:
    with expression
```

The from-clause is utilized to specify one or more sources for the select-expression. Each source is a reference to a collection of elements, and can be expressed as a binding expression. The binding expression can be an individual variable-binding or a list of variable-bindings separated by join operators. The individual variable-binding is where a label is given to reference each element of a collection in later clauses. The join-operator is used to specify a join operation for two given sources. The join operator specifies the type of join operation, which includes inner join, left (outer) join, right (outer) join, and full (outer) join. A join condition is specified using an on-condition expression. The on-condition expression is required when the join-operator is specified. Additionally, an optional where-clause may follow the from-clause to identify where a filtering condition for the sources is specified.

A. The Variable-Binding

In the variable-binding portion of the grammar, the type of the source collection, which is described in the grammar as a conditional-or-expression can be an IEnumerable or IEnumerator, and can be either untyped or typed. The variable binding is where an identifier is specified to reference each element of the IEnumerable or IEnumerator. A with keyword is utilized to specify one or more hints for a SQL table or view. The following is an example of a variable-binding expression:

```
// with strong type IEnumerable
void MyFun(IEnumerable<MyCustomer> customers) {
    ....
    ....from MyCustomer c in customers....
}
// with IEnumerator
void MyFun(IEnumerator<MyCustomer> customers) {
    ....
    ....from MyCustomer c in customers....
}
```

It should also be appreciated that the variable binding can be abbreviated when the source is a strongly typed IEnumerable or IEnumerator. Since it is strongly typed, a compiler can infer an element type relieving an author from having to specify the clement type. An author can also leave out an element variable name. In this case, the compiler can employ substantially the same name as the source for its element variable name.

For instance, the above example can be abbreviated:

```
// without explicitly specify the element type
void MyFun(IEnumerable<MyCustomer> customers) {
    ....
    ....from c in customers....
}
// without explicitly specify the element type and variable name
void MyFun(IEnumerable<MyCustomer> customers) {
    ....
    ....from customers....
}
// with IEnumerator
void MyFun(MyCustomer* customers) {
    ....
    ....from customers....
}
```

B. Hints

The with-clause is employed to specify hints. The with-clause is an expression that aids in limiting a scope of a query. The type of the expression can be determined by a composer, which is a compiler extension. For example, the SQL composer specifies this expression to be an enum value, and a value for hint is one of the enums defined in a SqlHint enum defined in a System.Data namespace:

```
namespace System.Data {
[Anonymous]
enum SqlHint {
    HoldLock,
    Serializable,
    RepeatableRead,
    ReadCommitted,
    ReadUncommitted,
    NoLock,
    RowLock,
    PageLock,
    TableLock
    TableLockExclusive,
    ReadPast,
    UpdateLock,
    ExclusiveLock
};
}
//customers is a SQL table
void MyFun(IEnumerable<MyCustomer> customers) {
    ....MyCustomer c in customers with SqlHint.NoLock....
}
```

C. Binding List

In accordance with the above-declared grammar, a binding list can either be a single binding or a binding and another binding list. Two areas of interest concerning a binding list are a list's scope and an affect of binding ordering. When more than one binding is specified, regardless of whether it is a variable binding or binding with join operator, the scope of the binding is independent of previous and subsequent bindings. This is the rule, since previous bindings are not available for attaining a scope of subsequent bindings and subsequent bindings are not available for attaining a scope previous bindings. The binding list rule can be further clarified by viewing the following examples:

. . . MyCustomner c in customers, MyPrice p in prices . . .

=====>this is valid

. . . MyCustomer c in customers, MyPrice p in GetMyPrices (c) . . .

=====>this is invalid because subsequent bindings can not see the previous bindings

. . . MyCustomer c in GetMycustomers(p), MyPrice p in prices . . .

=====>this is invalid because previous bindings can not see the subsequent bindings

However, it should be appreciated that an order of sources in a binding list may change a shape of a result set.

D. Binding with Join

The binding grammar as specified above reads:

```
binding:
    binding join-operator hintₒₚₜ binding on-condition
join-operator:
    inner join
    left join
    right join
    full join
on-condition:
    on conditional-or-expression
```

Note that an on-condition expression is required when a join-operator is specified, while a hint is optional. Additionally, it should be appreciated by those of skill in the art that a join can be nested. A precedence rule for nested join operators is from left to right. The following example illustrates a join between two IEnuinerables:

```
public class A {
  public int a1;
  public int a2;
}
public class B {
  public int b1;
  public int b2;
}
void myFunc(IEnumerable<A> aa, IEnumerable<B> bb) {
  ...A a in aa inner join B b in bb on a.a1 == b.b1....
  // For a projection on all the fields, it will produce
  // ==> IEnumerable<a row type with int a1, int a2, int b1, int b2>
  // ==> data is from {a.a1, a.a2, b.b1, b.b2}
}
```

The following is an example of a nested Join:

```
public class C {
  public int c1;
  public int c2;
}
```

void myFunc(IEnumerable<A>aa, IEnumerable<B>bb, IEnumerable<C>cc){ . . . A a in aa inner join B b in bb inner join C c in cc on c.c1==b.b1 on a.al==c.c1 . . .

// For a projection on all the fields, it will produce

//==>IEnumerable<a row type with int a1, int a2, int b1, int b2, int c1, int c2}>

//==>data is from {a.a1, a.a2, b.b1, b.b2, c.c1, c.c2}

Nonetheless, not all the elements will be returned as a result of the join operation. The elements returned depend on a condition specified in the on-condition and on the join operator itself.

F. On Condition

The join condition is specified in the on-condition expression. The result type of the on-condition is a Boolean type. In other words, the join operation is conditioned on whether the on-condition is true or false. If the condition is true, the join is executed; otherwise, the join is not performed. The on-condition expression is a required portion of a joined binding expression.

The bindings that refer to each element in a source collections are visible to the on-condition expression. For example, using the example in the binding with join section supra, the following on-condition expression is valid:

. . . A a in aa inner join B b in bb on a.a1==b.b1

Variables in scope can also be utilized in the on-condition and follow the same rules as when specified in the where-condition expression (discussed infra) as a search condition.

F. Type of Join

Four join operator keywords: inner join, left join, and right join are introduced, utilizing substantially the same semantics as the corresponding join operators in SQL.

The cross join operation in SQL does not require an on-condition and produces a Cartesian product. However, a new keyword is not introduced for cross join, because when no join operator is specified, it is by default a cross join operation.

The inner join keyword returns an element from either specified binding only if they have a corresponding element in the other source. In other words, the inner join disregards any elements in which a specific join condition, as specified in the on-clause, is not met. For example, assuming aa is IEnumerable<A>and has the following data:

| int a1 | int a2 |
|---|---|
| 1 | 10 |
| 2 | 20 |

and bb is IEnumerable<B>and has the following data:

| int b1 | int b2 |
|---|---|
| 2 | 20 |
| 3 | 30 |

The inner join produces:

```
void myFunc(IEnumerable<A> aa, IEnumerable<B> bb) {
    ...A a in aa inner join B b in bb on a.a1 == b.b1;
    // ==> type is IEnumerable<a row type with int a1, int a2, int b1,
    int b2>
    // ==> values are (2, 20, 2, 20)
    }
```

Outer joins are classified as two distinct join functions, left and right. The left join returns all elements from a left binding and matched elements from a right binding. If there are any elements from the left binding, which do not have a matching element from the right binding, then a right element is filled with NULL value. For example:

```
void myFunc(IEnumerable<A> aa, IEnumerable<B> bb) {
    ...A a in aa left join B b in bb on a.a1 == b.b1;
    // ==> type is IEnumerable<a row type with int a1, int a2, int b1,
    int b2>
    // ==> values are (1, 10, NULL, NULL), (2, 20, 2, 20)
    }
```

The right join returns all elements from right binding and the matched elements from the left binding. If there are any elements from the right binding which do not have matching element from the left binding, a left element is filled with NULL value. For example:

```
void myFunc(IEnumerable<A> aa, IEnumerable<B> bb) {
    ...A a in aa right join B b in bb on a.a1 == b.b1;
    // ==> type is IEnumerable<a row type that has int a1, int a2, int
    b1, int b2>
    // ==> value are (2, 20, 2, 20), (NULL, NULL, 3 , 30)
    }
```

The full join returns all elements from both bindings. The NULL value can then be used to fill any missing element content. For example:

```
void myFunc(IEnumerable<A> aa, IEnumerable<B> bb) {
      ...A a in aa full join B b in bb on a.a1 == b.b1;
    // ==> type is IEnumerable<a row type with int a1, int a2, int b1,
```

int b2>
// ==> values are (1, 10, NULL, NULL), (2, 20, 2, 20), (NULL, NULL, 3
, 30)
}

Because the result of outer join operations, left and right, could return NULL, a program compiler can employ an inference rule for promoting a non null-able type to a null-able type. Once the SQL schema is imported, the assembly can remember where the field came from. In a case where a field type is mapped to a non null-able type and needs to be promoted to a null-able type, the compiler may usc this information to promote the type to a SqlType. If the non null-able type is not from a SQL schema, the type may be promoted to an empty sequence type (e.g., type?).

1. G. Where Condition

The where condition specifies search criterion for bindings, and is denoted using the from-clause. The from-clause grammar is shown below.

```
from-clause:
    from binding-list where-clauseₒₚₜ
where-clause:
    where conditional-or-expression-select
conditional-or-expression-select:
conditional-or-expression
subquery-expression
```

A result type of the from-clause is visible to the where-clause. Furthermore, the result type of the where-clause is Boolean. Variables in scope can be utilized in the where-clause. For example:

. . . from aa where a1==“test” . . . or

string s=“test”;

. . . from aa where a1==s . . .

H. Where Condition Versus On Condition

The where-condition and the on-condition are similar in functionality but they apply to different conditions. In particular, the where-condition specifies a search condition and on-condition specifies a join condition. Additionally, the where-condition is optional and on-condition is required when join operators are used.

The reason an on-condition for join operations is employed with join operators is that it facilitates a more explicit and more readable expression than putting both the join condition and search condition inside the where-condition. Thus, in some cases it is possible to write a query both ways to achieve a substantially similar result. For instance, . . . A a in aa, B b in bb where a.a1==b.b1 produces the same result as . . . A a in aa inner join B b in bb on a.a1==b.b1.

II. Projections

Projections specify what is contained within a result set. Projections also allow an entity to specify fields (e.g., columns) from source elements (e.g., tables) to be in the result set. The field selection can be of one or more fields. However, all fields can be selected, for instance by employing a star (*). Projections allow a number of arbitrary expressions: top for limiting number of rows in the result set, singleton for strongly type checking one row returned and distinct for removing duplicates in the result set. A grammar for implementing projection functionality includes:

```
expression:
    quantification
    query-expression
query-expression:
    select [ singleton ] [distinct] [ top n [percent] [with ties] ]
projections
    from-clause groupby-clauseₒₚₜ orderby-clauseₒₚₜ
    projections:
        projection-star
        projection-list
    projection-star:
        *
    projection-list:
        projection
        projection , projection-list
    projection:
        conditional-or-expression as identifier(type-expression)
  identifier:
  conditional-or-expression
  n:
    constant-expression
```

The query-expression is where an author can specify what are in the result set, in what order and group, whether the result set value is a stream or single value, and the number of rows in the result set.

The result of the query-expression is a strongly typed IEnumerable or IEnumerator if singleton keyword is not specified. When the singleton keyword is utilized, the result set is one element. The type in both cases is an element type that contains fields specified in a projection list. Distinct, top and singleton are all optional keywords.

The following subsections describe, in further detail, some interesting aspects of projection. In particular, actions of selecting a field are described first and then methods of limiting elements in a result set are elucidated.

A. Selected Fields

The selected field(s) should be field(s) from a source row type. The selected field(s) form the row type of the result set. In other words, a row type of the result set include a type and name of the selected fields. For example:

```
class Customer {
    String FirstName;
    String LastName;
}
void myFunc(IEnumerable<Customer> cs) {
    //assume cs contains {“John”, “Doe”}, {“Jane”, “Doe”}
    // select all customers
      IEnumerable<[string FirstName, string LastName]> all =
      select FirstName, LastName
      from cs;
    // ==> type is IEnumerable<[string FirstName, string LastName]>
    // ==> the stream contains {“John”, “Doe”}, {“Jane”, “Doe”}
}
```

The row type of the cs.FirstName, cs.LastName projection includes the selected named fields, string FirstName, and string LastName. The type ofthe result set is an IEnumerable with the same row type since the source is IEnumerable.

To iterate through the result set without having to explicitly specify a return type, one can use a for each statement. A compiler can then infer the row type from the selected fields. Therefore, an author does not have to declare a variable type for the for each statement. For instance:

```
void myFunc(IEnumerable<Customer> cs) {
    //assume cs contains {“John”, “Doe”}, { “Jane”, “Doe”}
  foreach( row in select FirstName, LastName from cs) {
    Console.WriteLine(“FirstName is ” + row.FirstName);
    Console.WriteLine(“LastName is ” + row.LastName);
}
```

When the row type is assigned to another type, only a value is assigned whereas a label is discarded. In the above for each statement, since row variable is just a variable used to refer to the row type of the result set, an original label is preserved.

In the case where only the field name is specified and there is only one field selected, the row type of the result set can be just the underlying field type. For example:

```
void myFunc(IEnumerable<Customer> cs) {
    // select Customer where LastName is “Doe”
      IEnumerable<string> doe =
        select FirstName
        from cs
        where LastName == “Doe”;
    // ==> type is IEnumerable<string>
    // ==> the stream contains {“John”}, {“Jane”}
      IEnumerable<(string FirstName)> my =
      select FirstName
      from cs
      where LastName == “Doe”;
    // ==> type is IEnumerable<[string FirstName]>
    // ==> the stream contains {“John”}, {“Jane”}
}
```

Since one field is selected, the row type can be string. The row type in this case, however, can also be a row type that includes string.

In a case where an author desires to select all the fields from the source elements, this can achieved by either specifying all the field names or employing the star (*) as the shorthand. Specifying * is the same as specifying the fields in their default order from the meta-data. Furthermore, a projection with * is a label projection where the row type of the result set contains the original label. Thus,

```
// select all Customers
IEnumerable<[string FirstName, string LastName]> all =
    select *
    from cs;
==> type is IEnumerable<[string FirstName, string LastName]>
==> the stream contains {“John”, “Doe”}, {“Jane”, “Doe”}
```

is the same as

```
IEnumerable<[string FirstName, string LastName]> all =
    select FirstName, LastName
    from cs;
==> type is IEnumerable<[string FirstName, string LastName]>
==> the stream contains {“John”, “Doe”}, {“Jane”, “Doe”}
```

B. Top

The top keyword is utilized for limiting a number of rows returned in a result set. Tile rows are limited by specifying a percentage or number of rows to be output to the result set. This does not affect the result set type. It should be noted that if a value n is specified after the top keyword, then n is of type integer when no percent keyword is used. However, if percent keyword is also specified, only a first n percent of the rows are output from the result set. When specified with percent, n is a double. If the query includes an orderby-clause, the first n rows (or n percent of rows) ordered by the orderby-clause are output. If the query has no orderby-clause, the order of the rows is arbitrary.

The with ties keyword specifies that additional rows be returned from a base result set with substantially the same value in orderby columns appearing as last of a top n (percent) rows. This is significant because it is possible that a row or record would not be included in the result set if there were two or more records with the same value and a top percentage of rows have been specified. In addition, the with ties keyword can only be specified if an orderby-clause is specified.

For example:

```
void SelectWithTies(IEnumerable<Customer> cs) {
// select the first customers
IEnumerable<(string FirstName, string LastName)> first =
select top 1 *
from cs;
//==> type is IEnumerable<[string FirstName, string LastName]>
//==> the stream contains {“John”, “Doe”}
// select 50% of the customers
IEnumerable<[string FirstName, string LastName]> first =
    select top 50 percent *
    from cs;
//==> type is IEnumerable<[string FirstName, string LastName]>
//==> the stream contains {“John”, “Doe”} since cs only has two rows
IEnumerable<[string FirstName, string LastName]> first =
    select top 100 percent *
    from cs;
//==> type is IEnumerable<[string FirstName, string LastName]>
//==> the stream contains {“John”, “Doe”}, {“Jane”, “Doe”}
}
```

C. Singleton

The singleton keyword is employed when there is only one row in a result set and a programmer wants to strongly type the result set to be one row and not a stream. An explicit casting operation can give the same semantic as well. However, in a case where an author does not know a type of the row, the author will not be able to provide a type name for the explicit casting operation. Therefore, the singleton keyword allows authors to type the result set as one row without having to know a projected or element type.

The type of the result set when the singleton keyword is specified is the row type. If more than one row in the result set when singleton keyword is used, an exception will be raised.

The following is a coded illustration of an implementation of the singleton keyword:

```
void SelectSingleton(IEnumerable<Customer> cs) {
// select “Jane” and there is only one “Jane”
[string FirstName, string LastName] one =
    select singlton FirstName, LastName
    from cs
    where FirstName == “Jane”;
//==> type is [string FirstName, string LastName]
//==> the value is {“Jane”, “Doe”}
}
```

D. D. Distinct

The distinct keyword is used to remove duplicates in the result set. It does not change the type of result set. The following illustrates an exemplary implementation of the distinct keyword.

```
void SelectUnique(IEnumerable<Customer> cs) {
// select unique LastName
IEnumerable<string LastName> one =
    select distinct LastName
    from cs;
//==> type is IEnumerable<[string LastName]>
//==> the stream contains {“Doe”}
}
```

III. Sorting

Elements of the result set can be sorted or ordered by employing the orderby-clause.

The following is an example of an orderby-clause grammer.

```
orderby-clause:
      order by orderby-criterion-list
orderby-criterion-list:
      orderby-criterion
      orderby-criterion-list , orderby-criterion
orderby-criterion:
      conditional-or-expression orderby-operatorₒₚₜ
orderby-operator:
      asc
      desc
```

As mentioned, the orderby-clause specifics a sorting condition for a result set. The orderby-clause is optional however, when specified, it should follow the from-clause. The fields from source elements are visible for the orderby-clause. Two orderby-operators are supported: ascending and descending. The orderby-clause does not change a type of result set and it does not change a number of rows in the result set, it simply sorts the rows in the result set based on a condition specified in the orderby-clause. When no orderby-clause is specified, data is not returned in any particular order. For example:

```
void SelectOrderby(IEnumerable<Customer> cs) {
// select customers sorted by FirstName
IEnumerable<[string FirstName, string LastName]> all =
    select FirstName, LastName
from cs
    order by FirstName;
//==> type is IEnumerable<[string FirstName, string LastName]>
//==> the stream contains {“Jane”, “Doe”}, {“John”, “Doe”}
```

IV. Grouping and Aggregated Functions

The groupby-clause is used to produce aggregate values for each row in a result set. The following is an exemplary grammar for implementing grouping functions.

```
groupby-clause:
    group by partition-list having-clauseₒₚₜ
partition-list:
    partition
    partition-list , partition
partition:
    projection
```

The groupby-clause is employed to produce aggregate values for each row in the result set. When groupby-clause is employed, fields that are specified in the groupby-clause can appear in a projection list and fields that are not can only appear in a projection list in combination with aggregate functions.

When no orderby-clause is specified, data returned is not in any particular order. If an author wants data to be returned in a certain order, the ordering should be specified with the orderby-clause. In the following example, data is grouped by state.

```
public class C {
    string city;
  string state;
  int sale;
}
void myFunc(IEnumerable<C> cc) {
    // assume cc has (“Redmond”, “WA”, 100), (“Seattle”, “WA”, 2000)
    IEnumerable<string> ss =
        select state from cc group by state;
    // ==> type is IEnumerable<string>
  // ==> the stream contains {“WA”}
    // this is invalid
    // IEnumerable<string> ss =
    // select city from cc group by state;
}
```

Aggregate functions perfonn a calculation on a set of values and return a single value. Aggregate functions are normally used in combination of grouphy-clause but they can be used independently as well. When utilized without a groupby-clause, aggregate functions report one aggregate value for a select expression. Some functions that the present invention has built into the language are SQL aggregate functions including avg, max, binary_checksum, min, checksum, min, check_sum, sum, checksum_agg, stdev, count, stdevp, count_big, var, groupinga and varp. In addition to these build-in aggregates, the relational query expression 440 of the present invention supports user defined aggregates.

Aggregate functions can be specified on the field of the element from which an author wants to aggregate the set of values. Based on the SQL built in aggregate functions and requirements from user-defined aggregates, a compiler will be able to detect that an aggregate function is utilized. Accordingly, the compiler will know that this aggregate function is applied over the set of values from a specified field and should yield only one value. For example:

```
void myFunc(IEnumerable<C> cc) {
    // assume cc has (“Redmond”, “WA”, 100), (“Seattle”, “WA”, 2000)
    IEnumerable<[string state, int sumOfSale]> ss =
        select state, sum(c.sale)as sumOfSale from cc group by state;
    // ==> type is IEnumerable<(string state, int sumOfSale)>
    // ==> the stream contains {“WA”, 2100}
}
```

A. Having-Condition

One can limit groups that appear in a query by specifying a condition that applies to groups as a whole—an optional having-clause. After data has been grouped and aggregated, conditions in the having-clause are applied. Subsequently, only groups that meet the conditions appear in the query.

B. Having-Condition Versus Where-Condition

In some instances, an author might want to exclude individual rows from groups (using a where-clause) before applying a condition to groups as a whole (using a having-clause). A having-clause is similar to a where-clause, however a having-clause applies to groups as a whole (that is, to the rows in the result set representing groups), whereas the where-clause applies to individual rows. Nevertheless, a query can contain both a where-clause and a having-clause. In such a case, the where-clause would be applied first to individual rows in tables or table-structured objects in a diagram pane, grouping the rows that meet the conditions in the where-clause. Subsequently, the having-clause could be applied to rows in the result set that are produced by grouping. Groups that meet the having conditions would then appear in the query output.

V. Subqueries

A sub-query is a select expression that is nested inside a relational query expression or inside another sub-query. The following code depicts an exemplary grammar for implementing sub-queries.

```
where-clause:
        where conditional-or-expression-select
conditional-or-expression-select:
    conditional-or-expression
    subquery-expression
subquery-expression:
    existantial-expression
    in-expression
    quantification-expression
existantial-expression:
        exists query-expression
in-expression:
  expression in query-expression
quantification-expression:
        expression comparsion-operator quantification-operator ( query-
expression )
quantification-operator:
    all
    any
    some
```

It should be appreciated that a sub-query can be used anywhere an expression is allowed. Additionally, a sub-query may be denoted utilizing parentheses as in the following example.

```
void SubQuery{IEnumerable<MyPrice> m, IEnumerable<YourPrice> y) {
      IEnumerable<int> i = select m1.itemno
                from MyPrice m1 in m
                where m1.price == (select singleton y1.price
                        from YourPrice y1 in y
                        where y1.itemno == m1.itemno);
}
```

Note the use of the singleton keyword in the above sub-query expression. m I price is a single value, not a collection to be compared against it; therefore, the sub-query should produce a single value as well. The singleton keyword specifies the result set of the sub-query to be a single value and not a collection.

A. Exists Operator

In the sub-query grammar supra, an exists operator follows an existential-expression. The existential-expression is introduced for existence testing inside a relational SQL select expression. The result type of the existential-expression is Boolean. It returns true if a sub-query contains any elements. The following is an example of using exists operator and a sub-query.

```
void SubQueryExists{IEnumerable<MyPrice> m,
IEnumerable<YourPrice> y) {
      IEnumerable<int> i = select m1.itemno
                from MyPrice m1 in m
                where exists (select y1.price
                        from YourPrice y1 in y
                        where y1.itemno == m1.itemno);
}
```

B. In Operator

The sub-query grammar above also includes an in operator. The in operator can be utilized for existent testing as well. The left-hand side expression, appearing prior to an in operator, must produce a single value and not a collection. The right-hand side expression, appearing after the in operator, can be a single value or a collection. The result type of the left-hand side expression should be the same type as the element type of the result type of the right-band side expression.

The in-expression produces a boolean type and it returns true when the left-hand side value matches any of the right-hand side element. An example of using in operator and a sub-query includes:

```
void SubQueryExists{IEnumerable<MyPrice> m,
IEnumerable<YourPrice> y) {
      IEnumerable<int> i = select m1.itemno
                from MyPrice m1 in m
                where m1.price in (select y1.price
                            from YourPrice y1 in y
                            where y1.itemno == m1.itemno);
}
```

C. Quantification Expression

As declared above, the quantification expression comprises left-hand side expression, comparison operations, followed by quantification operation, and right-hand side expression. Comparison operators that introduce a sub-query can be modified by the quantification operators: all, any or some. The left-hand side expression is a single value where the right-hand side expression is a query-expression. The return type of the quantification expression is Boolean. Therefore, when the all operator is employed, it means that the comparison of the left-hand side to every element of right-hand side must be true. Whereas, when the any operator is utilized it means that as long as one of the comparisons is true, it is true. Additionally, it should be noted that the some operator is equivalent to the any operator. Finally, in the case where the sub-query does not return any values, the quantification expression will evaluate to false.

Therefore, in the following example, all means m l .price must be greater than every value of from (select yl.price from YourPrice yl in y).

```
void SubQueryAll{IEnumerable<Myprice> m,
IEnumerable<YourPrice> y) {
      IEnumerable<int> i = select m1.itemno
                      from Myprice m1 in m
                      where m1.price > all (select y1.price
                                    from YourPrice y1 in y);
}
```

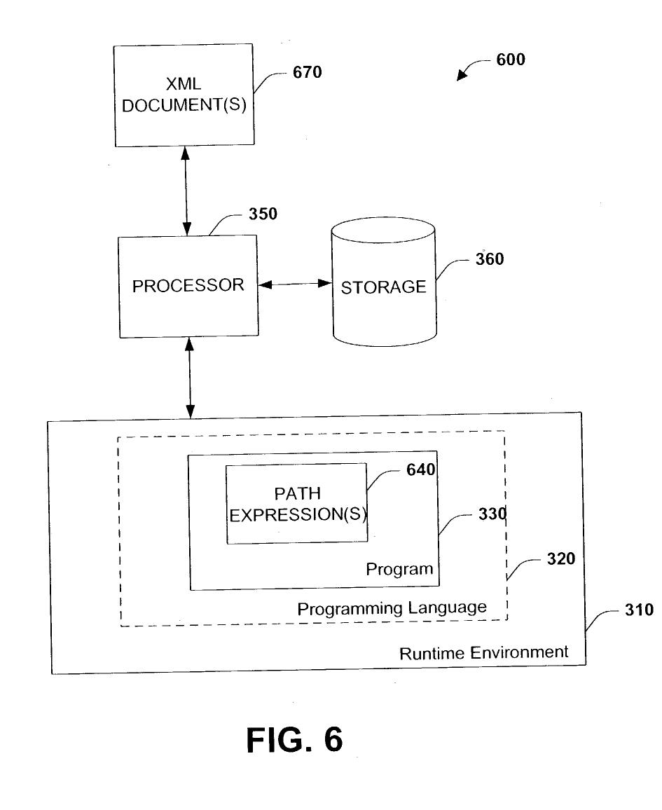

Turning now to FIG. 6, a block diagram of a system 600 for retrieving XML data is depicted. System 600 comprises runtime environment 310, programming language 320, program 330, path expression(s) 640, processor(s) 350, storage 360, and XML documents(s) 670. As with the system for retrieving relational data, programming language 320 is run on top of a runtime environment 310 (e.g., Common Language Runtime (CLR), Java Virtual Machine (JVM)). Runtime environment 310, initer alia, provides services to the programming language 320 such as automatic memory management, code security, and debugging facilities, which allows authors to focus on an underling logic of their applications rather than details of implementation. Programming language 320 provides a vocabulary and set grammatical rules that authors can use to implement desired functionality of their applications. Additionally, programming language 320 is a strongly typed object-oriented language that is tightly integrated with a compiler and type system. This allows programs to be thoroughly error checked prior to execution.

Program 330 employs the vocabulary and grammatical rules of programming language 320 to develop an application. Once the program 330 is written, it is compiled. The program may be compiled into an intermediate language (IL) or directly to machine code. Processor 350 can then execute program 330 via runtime environment 310. Processor 350 can also interact with storage 360 to facilitate execution of program 330

Path expression(s) 640 may be a part of program 330. Similar to relational select expression(s) 440, path expression(s) 640 are comprised of query terms, logical operators, and special characters that authors employ to specify how and which data is to be retrieved. However, where select expression(s) 440 are employed to retrieve data from relational tables, path expressions(s) 640 are utilized to retrieve data from XML literals or object instances in XML document(s) 670.

Path expression(s) 640 allow navigation to and retrieval of data in an XML document similar to the approach taken by the W3C recommended XML Path Language (XPath). Portions of XPath, along with extensions, and modification of XPath expressions have been mapped into language 320 to support strongly-typed XML queries. Thus, the present invention also models XML documents as a logical tree of nodes. To address parts of an XML document, the tree nodes are navigated. A starting point is known as a context node. A destination node is a result of a path expression, and a series of steps necessary to get from the context node to the destination node are referred to as location steps.

Similar to the select statement 440, path expression(s) 640 and language 320 provide support for a multitude of specialized operational expressions including filtering, aggregated expressions, groupby expressions, quantified expressions, sorting expressions, join expressions, and sequence expressions. Furthermore, programming language 320 is a subset of C# language. Therefore, all C# expressions are also supported by default in programming language 320.

When selecting fields from a child element of an XML document, a stream of values is returned of a same type as an underlying field. Consider the following XML object literal:

```
Message Hello =
<Message>
  <Header>
    <To>Wolfram</To><From>Erik</From>
  </Header>
  <Body>
    <Para>Hi Wolfram,</Para>
    <Para>It's time for coffee.</Para>
  <Body>
</Message>;
```

To access contents of a message body of this object instance via location steps the “.” notation can be utilized. Thus, Hello.Body.Para will return a stream of values containing Para members of the message with their underlying types:

[“Hi Wolfram,”, “It is tine for coffee”]

It should be noted that subexpression Hello.Body has a type (string Para;)+. In accordance with an aspect of the present invention, member access has been transparently lifted (“homomorphically extended”) over the stream to select the Para member of every individual tuple in that stream. Thus, the expression Hello.Body.Para was considered an abreviation for:

({for each((string Para;) p in Hello.Body) yield p.Para;});

According to an aspect of the present invention, a statement block in parentheses may appear as an expression. This allows the utilization of local variable declarations, loops, and return or yield statements within an expression. The value of a block expression ({b}) is syntactic sugar for a definition and immediate invocation of a closure ((( ){b})( )). If evaluation of a block flows out of the block via a statement-expression, the value returned by the block is the value of that expression.

Additionally, a statement block may be “applied” to a primary expression, e. {b}, which is an abbreviation for the loop ({for each(T! it in e){b}}) where e has type T* or any of the other stream types. Using this convention one can write the example above as simply Hello.Body.{ yield it.Para; }.

In existing object-oriented languages, accessing the above message would be less type-safe, more painful to write, and almost 20 times as long, because it is necessary to define a new class with a foreach( )method and create an instance of that class:

```
public class MessageHelper : IEnumerable{
    private Message m;
    public MessageHelper(Message b){ this.m = m; }
    public string foreach( ) {
        foreach((string Para;) p in b.Body) yield p.Para;
    }
}
```

Nonnal member access selects direct members of a singleton or stream of object instances. Alternatively, descendant queries select all recursively reachable accessible members (and they naturally also lilt over streams). For example using a descendant query, we can write an expression Message.Header.From as Message . . . From, which means select all From members, no matter at what depth. The next example resets the background color of all reachable controls (assuming there are no cyclic dependencies). In existing object-oriented languages, this requires both a loop and a recursive invocation on each child control:

```
void ResetBackColor(Control c) {
    c.BackColor = SystemColors.Control;
    foreach(Control c in c.Controls) ResetBackColor(c);
}
```

According to an aspect of the present invention, the descendant query c . . . Control::* is used to select all recursively reachable accessible members of type Control, and loop through the resulting stream to reset the BackColor of each of them:

void ResetBackColor(Control c) {c . . . Control::*.{it.BackColor=SystemColors.Control; };

}

Turning now to filtering an XML document, assume the following XML message is received:

```
<Message>
    <Header>
        <From>Koffi@otmail.com</From>
        <To>undisclosed receipients</To>
        <Subject>URGENT ASSISTANCE NEEDED</Subject>
    </Header>
    <Body>
      ...
      WITH OUR POSITIONS, WE HAVE SUCCESSFULLY SECURED FOR OURSELVES
    THE SUM OF THIRTHY ONE MILLION, FIVE HUNDRED THOUSAND UNITED
      STATES DOLLARS (US$31.5M). THIS AMOUNT WAS CAREFULLY MANIPULATED
      BY OVER-INVOICING OF AN OLD CONTRACT.
      ...
      IT HAS BEEN AGREED THAT THE OWNER OF THE ACCOUNT WILL BE
      COMPENSATED WITH 30% OF THE REMITTED FUNDS, WHILE WE KEEP 60%
      AS THE INITIATORS AND 10% WILL BE SET ASIDE TO OFFSET EXPENSES
      AND PAY THE NECESSARY TAXES.
      ...
      THIS TRANSACTION IS 100% RISK FREE.
      ...
    </Body>
</Message>;
```

A filter can be defined to alert a receiver of the message if the message contains certain strings. A code below uses filters, type-based descendant queries, and closures to define the MustRead closure that one can employ to filter interesting messages from a mailbox.

A filter expression e[p] removes all elements from a stream e of type T* (or any of the other stream types) that do not satisfy a given predicate p. The predicate p is any boolean expression and may use an implicit parameter it of type T!. Conceptually, the filter expression e[p] is simply a shorthand for expression e.{if(p) yield it;}. A message is interesting if any of its text content contains certain trigger words. The closure IsInteresting checks if a given string contains one of those words:

```
bool IsInteresting (string s){
    return
    ( s.IndexOf(“URGENT”) > 0
    || s.IndexOf(“YOUR ASSISTANCE”) > 0
    || s.IndexOf(“MILLION”) > 0
    || s.IndexOf(“100% RISK FREE”) > 0
    )
};
```

Given a message m, a descendant query m . . . string::* selects all recursively accessible members in m of type string. In this case, a stream of strings returned by m . . . string::* is the same as ({yield yield m.Header.From, m.Header.To, m.Header.Subject, m.Body.Para;}). At this point the IsInteresting predicate can be combined with a query to define a MustRead predicate that filters out all interesting words from a message and checks if a resulting stream is non-empty:

bool MustRead (Message m){
return m...string::*[IsInteresting(it)] != null;
};

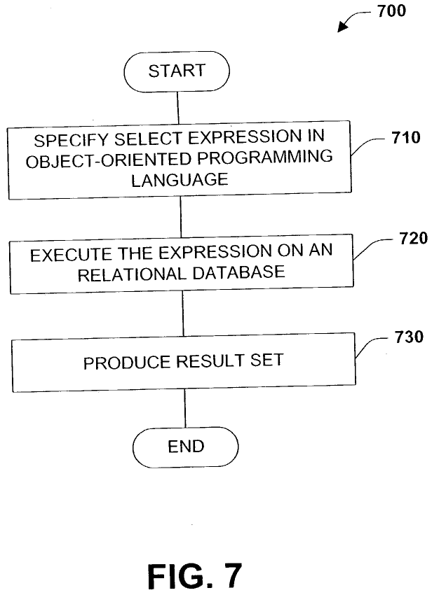

Turning now to FIG. 7, a flow diagram of a method 700 of retrieving relational data is depicted. At 710, a select expression is specified within a program of a strongly typed object oriented programming language. At 720, the select expression is executed on a relational database. Finally at 730, a result set is produce with retrieved data.

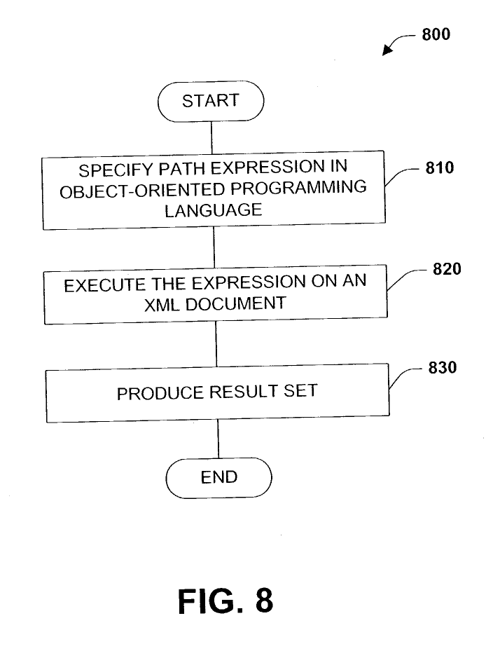

FIG. 8 is a flow diagram depicting a method of retrieving XML data. At 810, a path expression is specified within a program of a strongly typed object-oriented programming language. Next, at 820, the path expression is executed on an XML document. Subsequently, a result set is produces with the retrieve XML data.

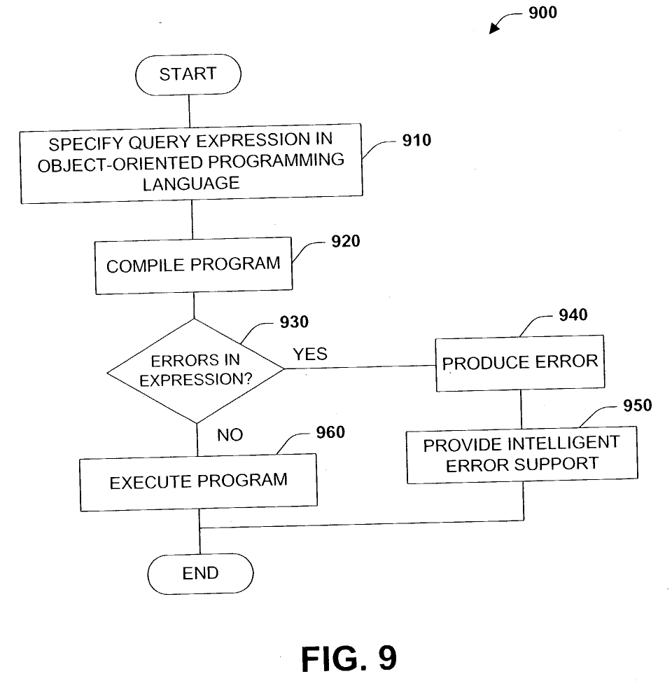

Turning to FIG. 9, a flow diagram of a method 900 for ensuring valid query expressions is illustrated. At 910, a query expression is specified in an object-oriented language. The query expression may be either a select expression for relational data or a path expression for self-describing data. At 920, the entire object-oriented program including one or more query expressions is compiled. At 930, a determination is made as to whether any errors resulted (e.g., syntax or type) from the compilation of any specified query expressions. If yes, then at 940, an error is produced. Next, at 950, intelligent support may be provided in response to the produced error, such as a suggested correction. Then the program terminates. However, if at 930 no errors are returned from the compilation process, then the program is executed at 960.

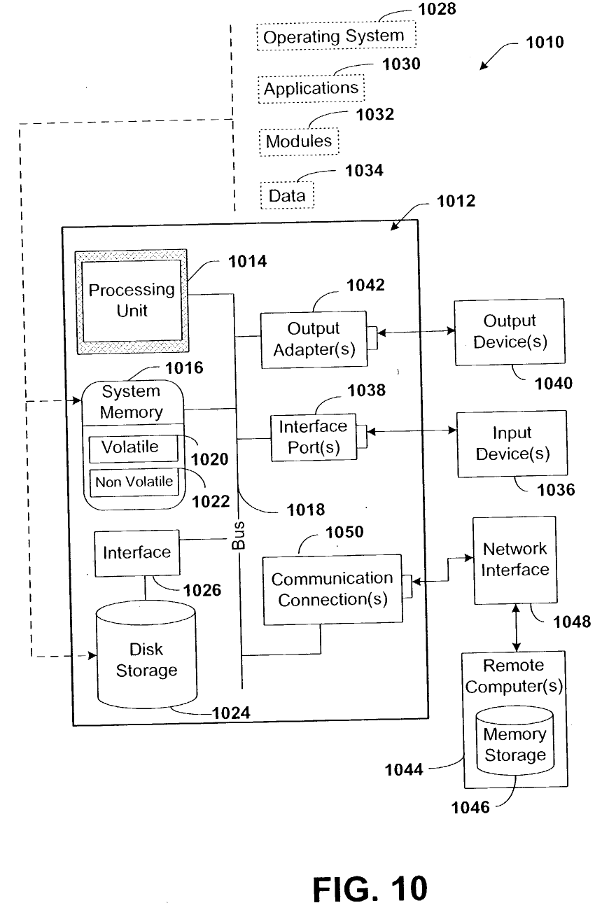

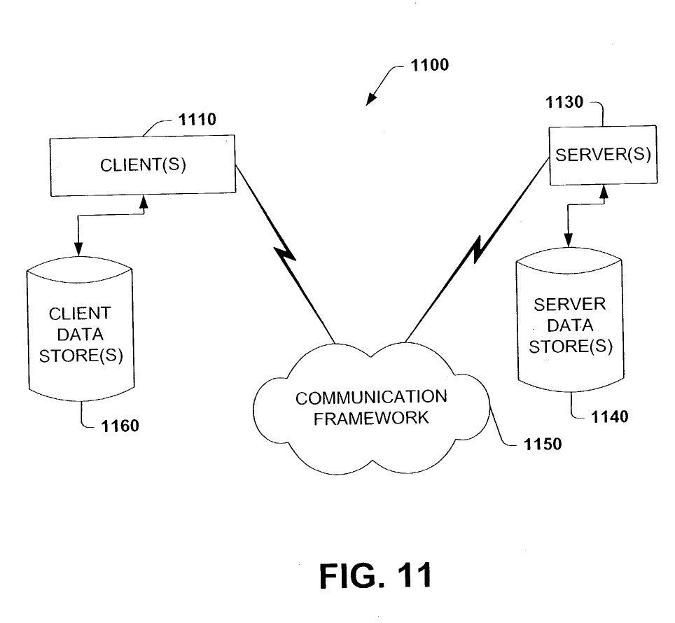

In order to provide a context for the various aspects of the invention, FIGS. 10 and 11 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perfonn particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practices on stand alone computers. In a distributed computing environment, program modules may be locate in both local and remote memory storage devices.

With reference to FIG. 10, an exemplary environment 1010 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 101 8 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer infonnation between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many fonns such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example a disk storage 1024. Disk storage 4124 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritablc drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the present invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output infonnation from computer 1012 to an output device 1040. Output adapter 1042 is provided to illustrate that there are some output devices 1040 like monitors, speakers, and printers, among other output devices 1040, that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1 130 can house threads to perfonn transformations by employing the present invention, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes examples of the present invention. It is, of course, not possible to describe every conceivable combination of components or methodologies for purposes of describing the present invention, but one of ordinary skill in the art may recognize that many further combinations and pennutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such tenn is intended to be inclusive in a manner similar to the term “comprising” as “comprising” is interpreted when employed as a transitional word in a claim.

What is claimed is:

1. A system for querying data comprising:
a component that accesses a database; and
a query expression specified in an object-oriented programming language, wherein execution of the query expression retrieves data in accordance with the query expression.

2. The system of claim 1, wherein the query expression is executed in a multi-language runtime environment.

3. The system of claim 1, wherein the query expression is strongly-typed and integrated into the type system and compiler of the object-oriented language.

4. The system of claim 3, wherein the query expression corresponds to a SQL select statement.

5. The system of claim 3, wherein the query expression corresponds to an XPath expression.

6. The system of claim 1, wherein the database contains XML documents.

7. The system of claim 1, wherein the database is a relational database.

8. A system for retrieving data comprising:
a component that accesses a relational database comprising one or more tables of data, and its associated database management system; and
a query expression specified in a strongly typed object oriented language, wherein data is retrieved in the fonn of a result set from the relational database after requesting data using the query expression.

9. The system of claim 8, wherein the query expression corresponds to a SQL select statement.

10. The system of claim 9, wherein the select statement contains a join operator employed to specify a join operation on two tables of data

11. The system of claim 10, wherein the join operation is an inner join.

12. The system of claim 10, wherein the join operation is a left outer join.

13. The system of claim 10, wherein the join operation is a right outer join.

14. The system of claim 10, wherein the join operation is a full outerjoin.

15. The system of claim 9, wherein the select statement contains a with-clause to specify hints.

16. The system of claim 9, wherein the select statement includes a top keyword for limiting the number of rows returned in the result.

17. The system of claim 9, wherein the result set is a stream.

18. The system of claim 17, wherein the select statement includes a singleton keyword to strongly type the result set to be one row and not a stream when there is only one row in the result set.

19. The system of claim 17, wherein the “distinct” keyword is incorporated into the select statement to remove duplicates in the result set.

20. The system of claim 17, wherein an orderby-clause is incorporated into the select statement to order the elements of the result set.

21. The system of claim 17, wherein an groupby-clause is incorporated into the select statement to produce aggregate values for each row in the result set

22. A system for retrieving data comprising:
a path expression specified in an object-oriented programming language; and
a component that receives data from an XML document via executing the path expression on the XML document such that the data is in the form of a result set from the XML document.

23. The system of claim 22, wherein the path expression is integrated into a compiler and type system of the object-oriented programming language.

24. The system of claim 22, wherein the result set is a stream of values.

25. The system of claim 24, wherein the result set is grouped according to criteria specified in the path expression.

26. A method for ensuring a valid query expression comprising:
specifying a query expression in an strongly typed object-oriented programming language;
compiling the query expression using the same compiler employed to compile an entire program; and
producing errors for invalid syntax and types.

27. The method of claim 26, further comprising suggesting changes to help a programmer fix the produced errors.

28. A computer readable medium having stored thereon the system of claim 1.

29. A computer readable medium having stored thereon computer executable instructions for carrying out the method of claim 26.

30. A system for ensuring a valid query expression comprising:
means for specifying a query expression in an strongly typed object-oriented programming language;
means for compiling the query expression using the same compiler employed to compile an entire program; and
means for producing errors for invalid syntax and types.

31. A data packet that passes between at least two computer processes comprising the system of claim 1.

32. A method of retrieving XML data comprising:
specifying a path expression within a program of a strongly typed object-oriented programming language;
executing the path on an XML document; and
producing a result set.

33. A method for retrieving relational data comprising:
specifying a SQL select statement within a program of a strongly typed object oriented programming language;
executing the statement on relational data in a database; and
producing a result set.
